(19) United States
(12) Patent Application Publication
(10) Pub. No.: US 2026/0148462 A1
(43) Pub. Date: May 28, 2026

(54) RECONSTRUCTION METHOD OF HUMAN BODY VIRTUAL AVATAR, ELECTRONIC DEVICE, AND NON-TRANSITORY COMPUTER-READABLE STORAGE MEDIUM

(71) Applicant: Beijing Zitiao Network Technology Co., Ltd., Beijing (CN)

(72) Inventors: Xiongzheng LI, Beijing (CN); Kun LI, Beijing (CN); Zhuo SU, Beijing (CN); Guidong WANG, Beijing (CN)

(21) Appl. No.: 19/397,619

(22) Filed: Nov. 21, 2025

(30) Foreign Application Priority Data
Nov. 22, 2024 (CN) 202411688745.1

(51) Int. Cl. G06T 13/40; G06T 7/73; G06T 7/80; G06T 17/20

(52) U.S. Cl. CPC G06T 13/40; G06T 7/75; G06T 7/80; G06T 17/20; G06T 2207/20084

(57) ABSTRACT

A reconstruction method of a human avatar, an electronic device, and a non-transitory computer-readable storage medium are provided. The reconstruction method of the human avatar includes: acquiring a plurality of images having a human body and a virtual human body dataset; acquiring a depth map from the plurality of images; and performing, based on the plurality of images, the depth map and the virtual human body dataset, three-dimensional reconstruction and rendering by using a trained neural network model to obtain a three-dimensional human body model and a corresponding rendered image.

### CROSS-REFERENCE TO RELATED APPLICATION

This application claims the priority to and benefits of Chinese Patent Application, No. 202411688745.1, which was filed on Nov. 22, 2024. The aforementioned patent application is hereby incorporated by reference in its entirety

### TECHNICAL FIELD

Embodiments of the present disclosure relates to a reconstruction method of a human avatar, an electronic device, and a non-transitory computer-readable storage medium.

### BACKGROUND

The research of a human avatar technology has important academic and application significance. With the development of augmented reality (AR), virtual reality (VR) and metaverse, creating high-quality digital human images has become a key factor in enhancing user experience and interaction effectiveness. This not only provides users with a more immersive experience, but also plays an important role in fashion design, virtual social interaction and other fields. However, one of the major challenges in this field is the way in which the data is acquired. Traditional reconstruction methods usually rely on expensive multi-view data, and the acquisition of these data sources is not only costly, but also difficult to popularize in practical applications. Recent studies tend to use more accessible data sources, such as a small number of RGB images. Although these methods reduce the cost to some extent, there are still problems such as long training time. In addition, a small number of images often makes it difficult to provide sufficient information. In addition, in a process of three-dimensional reconstruction of the human avatar, how to ensure both rendering quality and computational efficiency is an urgent problem.

### SUMMARY

In order to solve the existing problems, the present disclosure provides a reconstruction method of a human avatar, an electronic device, and a non-transitory computer-readable storage medium.

According to an embodiment of the present disclosure, there is provided a reconstruction method of a human avatar, comprising:
acquiring a plurality of images having a human body and a virtual human body dataset;
acquiring a depth map from the plurality of images;
performing, based on the plurality of images, the depth map and the virtual human body dataset, three-dimensional reconstruction and rendering by using a trained neural network model to obtain a three-dimensional human body model and a corresponding rendered image.

According to another embodiment of the present disclosure, there is provided an electronic device, comprising: at least one memory; and at least one processor, wherein the at least one memory is configured to store program codes, and the at least one processor is configured to execute the program codes stored in the at least one memory to perform the afore-mentioned reconstruction method of a human avatar.

According to yet another embodiment of the present disclosure, there is provided a non-transitory computer-readable storage medium, wherein the non-transitory computer-readable storage medium is configured to store program codes, and the program codes are configured to perform the afore-mentioned reconstruction method of a human avatar.

According to the present disclosure, based on a plurality of images, a depth map and a virtual human body dataset, three-dimensional reconstruction and rendering are performed with a trained neural network model to obtain a three-dimensional human body model and a corresponding rendered image, and the human avatar can be reconstructed by using a small number of images, which simplifies a data collection process. In addition, the reconstruction method of the present disclosure can ensure high computational efficiency while ensuring the rendering quality, and can further be used for real-time interaction.

### BRIEF DESCRIPTION OF DRAWINGS

The above and other features, advantages, and aspects of embodiments of the present disclosure will become more apparent from the following detailed description when taken in conjunction with the drawings. Throughout the drawings, the same or similar reference numerals indicate the same or similar elements. It should be understood that the drawings are schematic and that components and elements are not necessarily drawn to scale.

FIG. 1 is a flowchart of a reconstruction method of a human avatar according to an embodiment of the present disclosure.

FIG. 2 shows a structural diagram of a neural network model according to some embodiments.

FIG. 3 is a part of modules of a reconstruction apparatus of a human avatar according to another embodiment of the present disclosure.

FIG. 4 is a schematic structural diagram of an electronic device according to an embodiment of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments set forth herein. On the contrary, these embodiments are provided to enable a more thorough and complete understanding of the present disclosure. It should be understood that the drawings and embodiments of the present disclosure are for illustrative purposes only and are not intended to limit the protection scope of the present disclosure.

It should be understood that the various steps described in the method embodiments of the present disclosure may be executed sequentially and/or in parallel. Furthermore, method embodiments may include additional steps and/or omit the execution of the steps shown. The scope of the present disclosure is not limited in this respect.

As used herein, the term “including” and its variants are inclusive, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Related definitions of other terms will be given in the following description.

It is noted that the terms “first”, “second”, and the like in the present disclosure are only used for distinguishing different apparatuses, modules or units, and are not used for limiting the order or interdependence of the functions performed by these apparatuses, modules or units.

It is noted that references to “a” or “an” in the present disclosure are intended to be illustrative rather than limiting, and should be understood as “one or more” by those skilled in the art, unless the context clearly indicates otherwise.

The names of messages or information exchanged between apparatuses in the embodiments of the present disclosure are for illustrative purposes only, and are not intended to limit the scope of the messages or information.

Parametric modeling methods based on a small number of images, such as Skinned Multi-Person Linear model (SMPL) and SMPL-X, which are standard human body models for perception and learning, are among the most widely used technologies for human body reconstruction at present. These methods can generate accurate 3D models by parameterizing a shape and a pose of a human body, and quickly fit the human body in the image by optimizing these parameters. Its advantages are high speed and compatibility with traditional rendering pipeline, making it suitable for real-time applications. However, rendering of such models is mainly based on a mesh, resulting in limited expressive power and lower rendering quality. In order to overcome these limitations, it is contemplated to incorporate neural rendering or voxel representation to improve rendering quality and expressiveness.

Implicit methods based on a small number of images (like Deep Tetrahedral Travelling Mesh (DMTet) and Neural Radiation Field (NeRF)) have made important advances in the field of 3D reconstruction in recent years. NeRF is capable of generating highly realistic 3D rendering effects by using implicit functions which represents colors and densities in a scene. It models rays of light in a scene by training a network so that high quality images can be rendered from arbitrary viewing angles. In addition, NeRF is able to efficiently capture detail and illumination variations in complex scenes, making the generated 3D scenes more realistic and high degree of delicacy. This approach can not only apply to static scenes, but also captures dynamic effects, thus providing a strong support for applications such as virtual reality and augmented reality. DMTet is an advanced algorithm, which is specifically designed for generating high-quality three-dimensional meshes. It represents the three-dimensional shape as a tetrahedral mesh, and uses a dense matching technology to optimize the quality and geometric details of the mesh. A core advantage of DMTet is that it can generate meshes with high fidelity and low geometric error, which makes it perform well in the fields of three-dimensional reconstruction, computer graphics and computational geometry.

However, although these two methods can produce high-quality rendering results, they still face significant challenges in terms of time cost. It usually takes about 4.5 hours to generate a sample, which is clearly a significant bottleneck for applications that require rapid feedback or frequent updates. This high time consumption not only limits its widespread use in virtual reality and augmented reality applications with high interactivity requirements, but also imposes higher demands on the effective allocation of resources. Therefore, how to reduce computation time while maintaining high-quality rendering effects will become an important direction for future research.

Pre-trained generative large models are a class of deep learning models that are pre-trained on large-scale datasets, and have the ability to generate new data, and are widely used for various generation tasks such as text, images, and the like. Such models typically employ self-supervised learning or unsupervised learning to learn features and modes from data without explicit labels, followed by a small number of task-specific fine-tuning to achieve generative tasks.

DINAR aims at reconstructing the human avatar of an input image, mainly including two parts: a generative model and a refining model. The generative model reconstructs neural textures of the input image and synthesizes a rendered image through neural rendering. The model takes RGB images and a parametric SMPL-X human body model as inputs, and optimizes human body contour matching by combining an SMPLifyX method with a segmentation loss. The generated neural textures include the texture generated by StyleGAN2 and the texture sampled from the input image, with a final texture dimension being 256×256×21. In addition, the refining model is trained based on a denoising diffusion probability model (DDPM) to restore missing human body regions in the input image. In a training process, the model is optimized by minimizing a difference loss, a perception loss and an adversarial loss. However, the disadvantage of this method is that the rendering quality is relatively low, and it is more biased towards generating a tight human body, which may result in poor effect in processing complex poses or different body types, thereby limiting its application scope.

HAVEFUN proposes an implicit method for reconstructing a human avatar, aiming at supporting free-view rendering and free-posture animation. Given a small number of RGB images, this method generates a 3D representation containing triangular meshes, texture fields, skinning weights and mixed shapes of expressions. The core idea is to use DMTet to train with the reference and guidance of a small number of images. The method includes: initializing through a hybrid representation, allowing an arbitrary human body to be represented by using a defined tetrahedral mesh and a learnable vertex displacement, and then in combination with visual characteristics and camera viewing angle as conditions, using Zero123 to supervise the generation of images from different viewing angles; and finally, processing dynamic postures by parameterized mesh and skinning mechanisms. Although this method is excellent in generating high-quality images and maintaining multi-view consistency, it has some shortcomings in time efficiency, and the optimization process requires a long computation time, which limits its application in scenes that need real-time feedback.

Ihuman proposes a simple and effective method to create a drivable 3D human body virtual avatar from a monocular video. Ihuman uses the high efficiency of Gaussian splatting to model a dynamic 3D human body geometry and appearance. In this work, 3D Gaussian splatting is bound to corresponding triangular patches of a body template, thereby achieving an accurate and efficient human body modeling method. However, an input of this work is a monocular video, which is not as easy for users to obtain as a small number of images.

HumanSplat proposes a Gaussian splatting method to predict a static 3D human body from a small number of images. For example, HumanSplat includes a 2D multi-view diffusion model and a conversion model with a human body structure prior. It integrates a geometric prior and semantic features, and can achieve high-fidelity texture modeling. However, HumanSplat can only generate static 3D human body models, and cannot be directly animated, thus it is difficult to meet the requirements in applications such as virtual avatars and virtual social interactions that require dynamic interaction.

Therefore, while DINAR implements the reconstruction of the human avatar, its lower rendering quality, particularly when generating complex poses, may result in distortions or unnatural effects. This low-quality rendering affects the user experience such that the resulting animation appears insufficiently realistic in practical applications. In addition, the method is more biased towards generating a tight body structure, lacking adaptability to different body types and poses. This does not perform well in application scenes that need to process various body types or dynamic postures, limiting its application range.

Although HAVEFUN is outstanding in generating high-quality images, its optimization process requires a long computation time. Especially when processing complex reference images, the computational requirements increase significantly, resulting in slower model training and rendering speeds. This makes the implicit method difficult to apply in scenes that require fast feedback, such as fast animation generation, games, etc., due to the long computation time. The user's expectation of quick response cannot be met, which limits the practical application of this technology in dynamic interaction.

The existing explicit methods have relatively low rendering quality when generating human body virtual avatars, and are limited to tight human structures. The present disclosure will enhance the rendering quality by introducing a finer optimization mechanism, and ensure the robustness of a generated virtual character in different dynamic poses, so as to meet the requirements of different application scenes. The time efficiency of the implicit method in the optimization process is insufficient, which limits its application in some applications. The present disclosure will adopt a more efficient algorithm and model architecture to reduce the computation time required for training and rendering, and ensure that an efficient fast feedback ability can be maintained when processing complex scenes, so that the technology can be better applied to fields that need rapid response, such as virtual reality and games. Therefore, the present disclosure ensures the computational efficiency while pursuing the rendering quality.

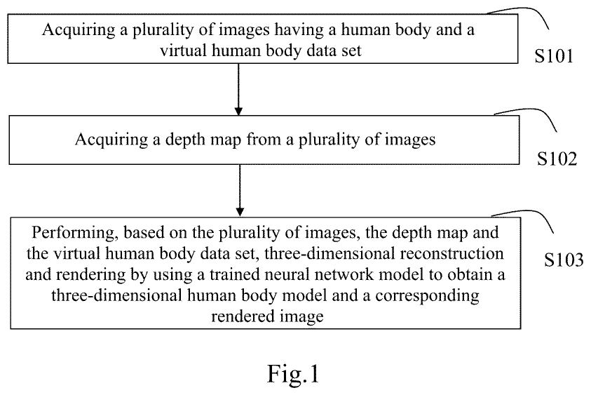

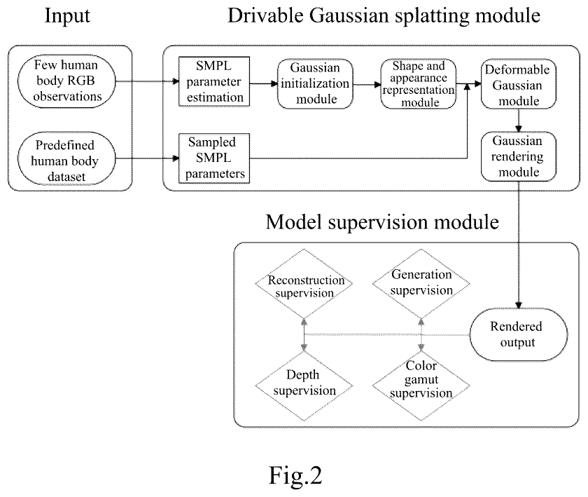

FIG. 1 provides a flowchart of a reconstruction method of a human avatar according to an embodiment of the present disclosure, and FIG. 2 shows a structural diagram of a neural network model according to some embodiments. The reconstruction method of the human avatar of the present disclosure may include step S101, acquiring a plurality of images having a human body and a virtual human body dataset. In some embodiments, the plurality of images may be images shot by a common RGB camera, and the number of the plurality of images may be typically 3 to 10, but the present disclosure is not limited thereto. In some embodiments, the virtual human body dataset is existing human-body-related data that has been collected and sorted, for example, human body-related shape parameters and pose parameters, which can be used for training machine learning models, performing computer vision tasks, performing biomechanical research and so on. In some embodiments, the virtual human body dataset can be acquired from these existing data by random sampling. In this way, virtual human body datasets representing different shapes and postures can be used to supervise the training model, so that it can be better generalized to the real scene, thereby enriching the poses of the reconstructed three-dimensional human body model and increasing the generalization.

In some embodiments, the method of the present disclosure may further include step S102, acquiring a depth map from a plurality of images. In some embodiments, the depth map can be estimated from the plurality of images through various existing pre-trained large models. In some embodiments, the plurality of input images, the depth map, the virtual human body dataset, etc. are normalized to unify the data format, so as to be adapted to input requirements of the model, including adjusting a resolution, normalizing pixel values and depth values, etc.

In some embodiments, the method of the present disclosure may further include step S103, performing, based on the plurality of images, the depth map and the virtual human body dataset, three-dimensional reconstruction and rendering by using a trained neural network model to obtain a three-dimensional human body model and a corresponding rendered image. In some embodiments of the present disclosure, the three-dimensional human body model and the corresponding rendered image can be obtained by performing, based on the plurality of input images, the depth map obtained from the plurality of images and the virtual human body dataset, three-dimensional reconstruction and rendering by the trained neural network model.

The present disclosure simplifies a data collection process by using a few images without providing videos, etc. Images from different viewing angles can be provided by using the virtual human body dataset, thereby increasing the rendering quality and generalization.

In some embodiments, with reference to FIG. 2, the performing, based on the plurality of images, the depth map and the virtual human body dataset, three-dimensional reconstruction and rendering by using a trained neural network model to obtain a three-dimensional human body model and a corresponding rendered image includes: acquiring a shape parameter and a first pose parameter of the human body from the plurality of images; generating an initial three-dimensional human body template mesh based on the shape parameter and the first pose parameter; generating initial Gaussian mixture model parameters based on the initial three-dimensional human body template mesh; generating a density field and a color field of a three-dimensional scene based on the initial Gaussian mixture model parameters; generating deformed Gaussian mixture model parameters based on the initial Gaussian mixture model parameters, the first pose parameter and a second pose parameter from the virtual human body dataset; and obtaining the three-dimensional human body model and the corresponding rendered image based on the deformed Gaussian mixture model parameters and external parameters and internal parameters of a camera for acquiring the plurality of images.

In some embodiments, the existing SMPL model can be used for parameter estimation, and a pose parameter θ and a shape parameter β of the human body can be estimated from the plurality of input images, and these parameters can be used to construct the three-dimensional model of the human body and generate the initial three-dimensional human body template mesh.

In some embodiments, the generating initial Gaussian mixture model parameters based on the initial three-dimensional human body template mesh includes: taking vertices of the initial three-dimensional human body template mesh as point cloud locations of a Gaussian mixture model, and initializing parameters of the Gaussian-mixture model by using a normal direction of a mesh face as a depth direction, to generate the initial Gaussian mixture model parameters. In some embodiments, as a Gaussian initialization module in a drivable Gaussian splatting module, an initial three-dimensional human body template mesh and a skeleton structure B estimated by SMPL along with its corresponding weight W are input, and a three-dimensional human body represented by initial Gaussian Mixture Model parameters G {μ, R, σ, c} is output. In some embodiments, the purpose of initializing the Gaussian module is to convert the input three-dimensional template into a Gaussian representation suitable for subsequent deformation and rendering, and this process provides basic shape and appearance information for a subsequent module. For example, a predefined template mesh M is used to initialize the Gaussian mixture model parameters, that is, a vertex Vc of the predefined template mesh is used as a location μ of the Gaussian mixture model, a normal direction of a mesh face is used as a depth direction R, and a density σ and a color c are randomly initialized. In addition, joint information and weight W of a predefined skeleton B are used to determine a skinning weight of each Gaussian component.

In some embodiments, the generating a density field and a color field of a three-dimensional scene based on the initial Gaussian mixture model parameters includes: determining a Gaussian density for each Gaussian component; determining a color of the corresponding Gaussian component based on the Gaussian density; and determining the density field and the color field of the three-dimensional scene based on the Gaussian density and the color of each Gaussian component. This is achieved by a shape and appearance representation module in FIG. 2. The shape and appearance representation module is responsible for explicitly representing the shape and appearance of a human body by using the Gaussian model and calculating density and color information of a given location, thus providing necessary visual features for subsequent rendering. For example, for each Gaussian component i, its density contribution is calculated; and the color of the Gaussian component i is calculated according to the Gaussian density; and then the density and color of the whole scene are obtained by summing up contributions of all Gaussian components.

In some embodiments, the generating deformed Gaussian mixture model parameters based on the initial Gaussian mixture model parameters, the first pose parameter, and a second pose parameter from the virtual human body dataset includes: using a learnable skinning weight to enable each Gaussian component to deform by using the first pose parameter and the second pose parameter; and determining the transformation of the Gaussian component and determining a deformed mean and rotation to determine deformed Gaussian mixture model parameters. This is achieved by a deformation Gaussian module in FIG. 2. The deformation Gaussian module achieves the deformation of the Gaussian model by using forward skinning deformation and learnable skeleton adjustment, thereby capturing dynamic changes of people and clothes. The transformation of each Gaussian component includes a location μ(i) and rotation R(i). For example, the learnable skinning weight W is used to enable each Gaussian component to deform by using a human body parametric template; the transformation of the Gaussian component is computed, and the mean and rotation after deformation are computed; and the deformation capability is enhanced through the introduction of the second pose parameters or a latent skeleton.

In some embodiments, the obtaining the three-dimensional human body model and the corresponding rendered image based on the deformed Gaussian mixture model parameters and external parameters and internal parameters of a camera for acquiring the plurality of images includes: converting a mean, a covariance, a color and a density of three-dimensional Gaussian into a two-dimensional representation. This is achieved by a Gaussian rendering module in FIG. 2. In some embodiments, the Gaussian rendering module is responsible for rendering the three-dimensional Gaussian mixture model into a two-dimensional image, and the conversion from a three-dimensional scene to a two-dimensional image is achieved through a differentiable rendering technology. For example, a mean, a covariance, a color and a density of three-dimensional Gaussian are converted into a two-dimensional representation. Then, the rendering can be performed using a usual ordered color accumulation method. In this way, a rendered output, that is, a rendered two-dimensional image, can be obtained.

The 3D Gaussian splatting adopted in the embodiments of the present disclosure is a method for three-dimensional scene rendering by using a Gaussian splatting technology. It combines the advantages of Gaussian distribution and point cloud data. The efficient, realistic and continuous representation of three-dimensional objects or scenes are realized by performing Gaussian spot rendering on point clouds in a three-dimensional space. In three-dimensional rendering, a traditional mesh model needs to represent a three-dimensional surface by triangles. Although this method is accurate, it is inefficient when processing very complex or sparse three-dimensional data (such as point clouds). To solve this problem, 3D Gaussian splatting provides an efficient method, which expands each point in the point cloud into a Gaussian distribution, and generates continuous surfaces and textures through the superposition of these Gaussian distributions. The core idea of 3D Gaussian splatting is as follows: converting the point cloud into Gaussian spots, wherein each point is not only a space coordinate, but also a three-dimensional “spot” spatially expanded through a Gaussian function; and rendering by the superposition of spots, wherein a continuous surface can be generated and details and irritation effects of the object surface can be captured through the superposition of multiple Gaussian spots.

Compared with a traditional triangular mesh method, the 3D Gaussian splatting directly processes the point cloud, which avoids complicated mesh generation and ray tracing processes, achieving high-quality rendering with low computational resources. The 3D Gaussian splatting has obvious advantages in the field of point cloud rendering, especially in efficiency, quality and applicable scenes. The 3D Gaussian splatting can render directly based on point cloud data without generating complex triangular meshes. This makes it possible to greatly increase the rendering speed when processing large-scale point cloud data, especially suitable for real-time rendering application scenes, such as virtual reality (VR), augmented reality (AR) and game engines. In addition, the 3D Gaussian splatting can process sparse and dense point cloud data and generate high-quality rendering results without relying too much on a high-precision point cloud density. In addition, the 3D Gaussian splatting can effectively handle objects with complex shapes and textures. When processing complex geometric shapes or non-rigid objects (such as clothes, human bodies, etc.), it can generate a realistic dynamic effect and is not limited by traditional polygon mesh methods. The method using the Gaussian model in the present disclosure significantly increases the computational and rendering efficiency.

In some embodiments, in a training process of the neural network model, a reconstruction loss function, a depth consistency loss function, a score distillation sampling generation loss function and a color gamut consistency loss function are used for model supervision. In some embodiments, a model supervision module optimizes the model performance by calculating various losses, so as to ensure that the generated image matches the input image in multiple dimensions, so that the rendering quality and the generalization in different poses are increased. In some embodiments, a reconstruction loss measures a difference between a Gaussian-rendered original view image “I_render” and an original image “I_real” (i.e., input multiple images) by using an L1 loss and a structural similarity metric (SSIM) loss. The L1 loss focuses on a pixel-level absolute difference, while SSIM considers structural information of the image, which together helps improve the image quality. In some embodiments, the depth consistency loss evaluates the accuracy of the model in depth information by comparing a Gaussian-rendered depth map “D_render” with a depth map “D_real” of an original image. The depth consistency loss ensures that the model not only performs well in a two-dimensional space, but also captures a correct structure in a three-dimensional space. In some embodiments, the score distillation sampling (SDS) generation loss aims to take advantage of the difference between an input image “I_real” and a Gaussian-rendered image “I_diff” from different viewing angles, so as to ensure that the model maintains a consistent spatial structure in a generation process, and can generate natural and coherent results especially in different pose scenes. In some embodiments, a color gamut consistency loss helps ensure that the generated image is consistent with the real image in color performance by calculating the consistency of the input image “I_real” and the Gaussian-rendered image “I_diff” at different viewing angles in a color space. This process increases not only the visual aesthetic feeling of the image, but also the realism of the model.

Through the comprehensive computation of these losses, the model supervision module effectively guides the model optimization so that the final generated image remains consistent with the original image in structure, depth and color, thereby increasing the quality and generalization of visual effects.

In some embodiments, the SDS generation loss is a loss function for training the generative model, which is widely used in the field of 3D generation, such as used for generating a 3D model through natural language description or an image. The SDS loss guides the consistency between generated three-dimensional data and the description of a target text or image by combining a pre-trained diffusion model. This method was originally designed to optimize a potential representation in 3D shape generation, but it can also be extended to other generation tasks. The core idea of the SDS loss is to distill knowledge of the pre-trained diffusion model into the generative model by score distillation. For example, the pre-trained diffusion model (such as stable diffusion) usually performs well in a 2D image generation task, and thus in a 3D generation task, the SDS loss will utilize gradient information of the diffusion model to ensure the consistency between a generated 3D object and target description (such as a natural language or image).

In some embodiments, a flow of the SDS generation loss can be summarized as the following steps S1 to S4. Step S1, use of the pre-trained diffusion model: for example, using a diffusion model (for example, a text-image diffusion model) that has been trained on 2D tasks as a teacher model, and providing, by the teacher model, a score in a high-dimensional space, which indicates a matching degree between the target description and a generated result. Step S2, the generative model and optimization: for example, generating, by a generative model in a three-dimensional generation task, a three-dimensional object according to some potential parameters (such as a shape and a texture of the 3D model), wherein through the SDS loss, the generative model learns how to adjust its parameters to maximize the consistency with the target description. Step S3, score distillation: for example, generating, by the diffusion model, a score gradient in its sampling process, which indicates a degree of discrepancy between the generated 2D representation and the target text description or the image, and guiding, by the SDS loss, the 3D generative model to adjust along this gradient, allowing the generated three-dimensional shape to better fit the target description in the 2D projection of the diffusion model. Step S4: loss calculation: for example, calculating, by the SDS loss, a loss value by comparing the similarity between the 2D projection of the generated three-dimensional object from different viewing angles and the target description. Through backpropagation, the parameters of the generative model will be updated, so that the generated results can be better fit the target description. The SDS loss can be high-efficiently combined with a three-dimensional generation task, so that the generative model can generate a realistic three-dimensional model according to the text. In addition, SDS makes full use of the knowledge already learned in the pre-trained diffusion model, so that the need to retrain a large number of complex models is eliminated and the training efficiency is increased. In addition, by comparing the 2D projection of multiple views with the object description, the SDS loss ensures that the generated three-dimensional model meets the requirements at different viewing angles, resulting in a higher-quality three-dimensional shape.

In some embodiments, a deep learning framework (PyTorch) is used to construct and train the neural network model of the embodiments of the present disclosure, and an optimizer uses a common optimization algorithm (Adam) to adjust the weight of the model, thus gradually reducing the error. Learning rate settings and weight decay strategies are adjusted to ensure that the model does not overfit while converging. In some embodiments, in the neural network model of the embodiments of the present disclosure, a plurality of preprocessed RGB images, a depth map and a corresponding virtual human body dataset (poses and shapes) are input the neural network model, and the neural network model outputs a model-generated reconstructed three-dimensional human body model and a corresponding rendered image. An objective of the neural network model of the embodiments of the present disclosure is to generate a rendered image that is consistent with input data and can be generalized in different poses. The neural network model of the embodiments of the present disclosure gradually increases the accuracy of its output by optimizing errors between modules (such as depth consistency errors, etc.), and in the training process, model parameters are optimized through backpropagation, enabling the generated results to gradually approach real scenes.

In some embodiments, the neural network model of the embodiments of the present disclosure can be algorithmically tested, including model verification, performance evaluation, result presentation and iterative optimization, etc. For example, in the model verification, the generalization ability of the model is verified by inputting never-seen test data, so as to ensure that it can be well generalized outside a training set. In a verification process, the ability of the model to handle different human body poses, shapes and visual angle changes is examined and its performance in different scenes is evaluated. For example, in the performance evaluation, the performance of the model is evaluated by various quantitative metrics (such as the depth map consistency, the reconstruction accuracy, etc.); in addition, combined with qualitative evaluation, the visual quality is ensured by comparing the input and generated three-dimensional models and rendering results. For example, in the result display, three-dimensional human body reconstruction and rendering effects generated by the model are displayed, and compared with the input image and the real scene, the effect and performance of the algorithm are displayed intuitively. Displaying results from multiple viewing angles and multiple poses helps comprehensively evaluate the applicability of the model in practical applications. For example, in iterative optimization, a model architecture or a training strategy are further adjusted according to test results and performance evaluation feedbacks. Through iterative optimization, the performance of the model is continuously increased to ensure its stability and reliability in practical applications.

The reconstruction method of the embodiments of the present disclosure is highly practical, and it can be directly applied to the actual scenes based on a small number of images without any post-processing steps. This means that users can directly obtain the results, and the overall efficiency is increased. Especially in applications that need quick feedback, such as virtual avatars and virtual social interaction scenes, it can quickly generate realistic and usable virtual characters. In algorithm design, the embodiments of the present disclosure introduces 3D Gaussian splatting and an SMPL-X (Extensible Skinned Multi-Person Linear Model) technology. In various life scenes, it can be accurately captured and performs three-dimensional human body reconstruction realistically. This precision and robustness enable the algorithm to work stably and to be very adaptable, particularly in environments such as virtual reality and augmented reality where fast interaction is required. In addition, the embodiments of the present disclosure provides deep optimization on the design of the loss function, increasing the realism of the reconstruction effect from multiple dimensions. For example, the loss function includes the following functions a) to d). Loss function a) an SDS generation loss: it ensures that the model maintains a consistent spatial structure in a process of generation, and can generate natural and coherent results especially in different pose scenes. Loss function b) a depth consistency loss: by introducing the consistency constraint of depth information, a depth structure of the generated three-dimensional human body is consistent with that of a real image, and the accuracy of three-dimensional reconstruction is increased. Loss function c) a color gamut consistency loss: color distribution is further optimized to make the generated image more natural in color appearance, avoiding a color cast phenomenon. Loss function d) a reconstruction loss: it ensures that the model is highly consistent with original data in pose and shape reconstruction, avoiding degradation of the overall reconstruction performance due to over-optimization of a single metric. Through the comprehensive optimization of these loss functions, the model has been increased at all levels, ensuring a high realism of the generated image.

The algorithm of the embodiments of the present disclosure is optimized to generate highly realistic three-dimensional images and poses in different environments. This high sense of reality enables the algorithm to be widely used in virtual characters, virtual social interaction, digital entertainment, etc. where there is a high requirement for visual realism. In addition, the algorithm of the embodiments of the present disclosure shows better robustness when handling various complex pose changes, and even in a case of extreme actions, and the model can stably output high-precision reconstruction results. This robustness ensures the reliability of the algorithm in real-world applications, especially in scenes that require dynamic feedback, such as motion capture, virtual social interaction and motion analysis, and provides better user experience. Through these improvements, the reconstruction method of the embodiments of the present disclosure has improvement in practicability, algorithm details and generation effects.

The embodiments of the present disclosure proposes a framework for deep learning of the human avatar using 3D drivable Gaussian splatting based on a small number of images. This framework combines the advantages of implicit and explicit methods and increases the computational efficiency while ensuring the rendering quality. The 3D Gaussian splatting converts the three-dimensional human body template and pose information into a Gaussian mixture representation suitable for deformation and rendering, so that the framework can quickly adapt to the changes of different poses while maintaining efficient rendering speed. In addition, the embodiments of the present disclosure solves the problem of sparsity of appearance information due to a small number of images by introducing a pre-trained generative large model and a color consistency loss. By combining the advantages of the generative model, the ability to capture image details in an appearance reconstruction process is increased, and the color consistency loss ensures the color uniformity of the reconstructed human body at different angles, thereby greatly increasing the quality of the appearance reconstruction. In addition, the generalization ability of existing reconstruction methods is poor, especially in the case of reconstruction of different poses, the reconstruction effect is not stable enough to guarantee the consistency. According to the embodiments of the present disclosure, by constructing the virtual human body dataset and introducing the depth consistency loss in different poses, the generalization ability of the algorithm is significantly increased. The diversity of the predefined virtual human body datasets provides abundant training samples, and the depth consistency loss ensures the stability and consistency of the reconstructed human body in different poses through the depth constraint across poses. This enables the reconstruction method to better adapt to scenes with various complex poses.

Therefore, the reconstruction method of the embodiments of the present disclosure can be directly used in the actual scenes without any post-processing. By combining a deep learning mode of the 3D Gaussian splatting, the training time of the model is greatly reduced. By combining the pre-trained generative large model and the color consistency loss, the quality of appearance reconstruction is greatly increased. By combining the predefined virtual human body dataset and the depth consistency loss, the generalization ability of different poses is greatly increased.

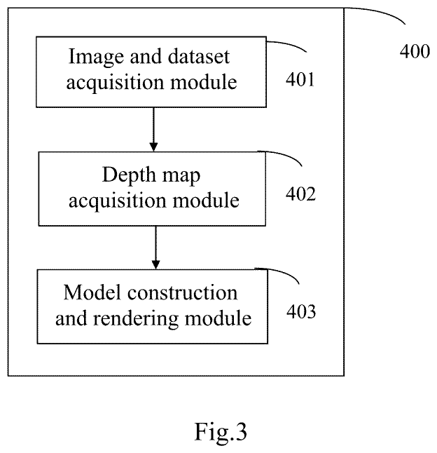

The embodiment of the present disclosure further provides a reconstruction apparatus 400 of a human avatar. FIG. 3 shows a reconstruction apparatus 400 of a human avatar according to some embodiments. The reconstruction apparatus 400 of a human avatar includes: an image and dataset acquisition module 401, a depth map acquisition module 402 and a model construction and rendering module 403. In some embodiments, the image and dataset acquisition module 401 is configured to acquire a plurality of images including a human body and a virtual human body dataset. In some embodiments, the depth map acquisition module 402 is configured to acquire a depth map from the plurality of images. In some embodiments, the model construction and rendering module 403 is configured to perform, based on the plurality of images, the depth map and the virtual human body dataset, three-dimensional reconstruction and rendering by using a trained neural network model to obtain a three-dimensional human body model and a corresponding rendered image.

It should be understood that the contents described regarding the reconstruction method of the human avatar is also applicable to the reconstruction apparatus 400 of the human avatar here, and detailed descriptions thereof are omitted here for simplicity purposes.

In some embodiments, performing, based on the plurality of images, the depth map and the virtual human body dataset, three-dimensional reconstruction and rendering by using a trained neural network model to obtain a three-dimensional human body model and a corresponding rendered image includes: acquiring a shape parameter and a first pose parameter of the human body from the plurality of images; generating an initial three-dimensional human body template mesh based on the shape parameter and the first pose parameter; generating initial Gaussian mixture model parameters based on the initial three-dimensional human body template mesh; generating a density field and a color field of a three-dimensional scene based on the initial Gaussian mixture model parameters; generating deformed Gaussian mixture model parameters based on the initial Gaussian mixture model parameters, the first pose parameter and a second pose parameter from the virtual human body dataset; and obtaining the three-dimensional human body model and the corresponding rendered image based on the deformed Gaussian mixture model parameters and external parameters and internal parameters of a camera for acquiring the plurality of images. In some embodiments, the generating initial Gaussian mixture model parameters based on the initial three-dimensional human body template mesh includes: taking vertices of the initial three-dimensional human body template mesh as point cloud locations of a Gaussian mixture model, and initializing parameters of the Gaussian-mixture model by using a normal direction of a mesh face as a depth direction, to generate the initial Gaussian mixture model parameters. In some embodiments, the generating a density field and a color field of a three-dimensional scene based on the initial Gaussian mixture model parameters includes: determining a Gaussian density for each Gaussian component; determining a color of the corresponding Gaussian component based on the Gaussian density; and determining the density field and the color field of the three-dimensional scene based on the Gaussian density and the color of each Gaussian component. In some embodiments, the generating deformed Gaussian mixture model parameters based on the initial Gaussian mixture model parameters, the first pose parameter and a second pose parameter from the virtual human body dataset includes: with a learnable skinning weight, causing each Gaussian component to deform by using the first pose parameter and the second pose parameter; and determining the transformation of the Gaussian component and determining a deformed mean and rotation to determine deformed Gaussian mixture model parameters. In some embodiments, the obtaining the three-dimensional human body model and the corresponding rendered image based on the deformed Gaussian mixture model parameters and external parameters and internal parameters of a camera for acquiring the plurality of images includes: converting a mean, a covariance, a color and a density of three-dimensional Gaussian into a two-dimensional representation. In some embodiments, in a training process of the neural network model, a reconstruction loss function, a depth consistency loss function, a score distillation sampling generation loss function and a color gamut consistency loss function are used for model supervision.

In addition, the embodiments of the present disclosure further provides an electronic device, including: a memory and a processor, wherein the memory is configured to store program codes, and the processor is configured to execute the program codes stored in the memory to perform the reconstruction method of the human avatar in the above embodiments of the present disclosure.

In addition, the embodiments of the present disclosure further provides a non-transitory computer-readable storage medium, wherein the computer storage medium stores program codes, and the program codes are configured to perform the aforementioned reconstruction method of the human avatar.

The reconstruction method and apparatus of the human avatar of the embodiments of the present disclosure are explained above based on the embodiments and application examples. In addition, the embodiments of the present disclosure also provides a terminal and a storage medium, which are described below.

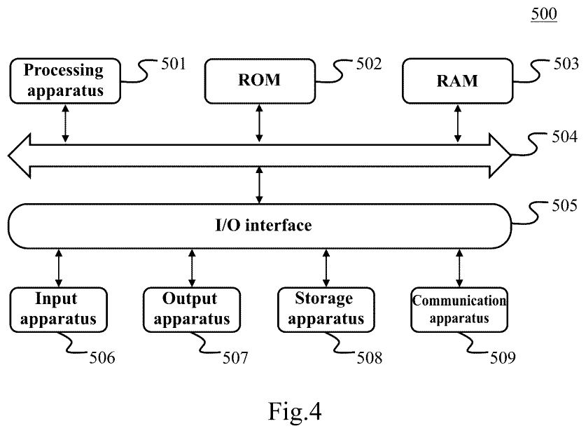

Next, with reference to FIG. 4, it shows a schematic structural diagram of an electronic device (such as a terminal device or a server) 500 suitable for implementing the embodiment of the embodiments of the present disclosure. The terminal devices in the embodiments of the present disclosure may include, but not limited to, mobile terminals such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal) and the like, and fixed terminals such as a digital TV, a desktop computer and the like. The electronic device shown in FIG. 4 is only an example, and should not bring any limitation to the functions and application scope of the embodiments of the present disclosure.

As shown in FIG. 4, the electronic device 500 may include a processing apparatus (for example, a central processing unit, a graphics processing unit, etc.) 501, which may perform various appropriate actions and processes according to programs stored in a read-only memory (ROM) 502 or programs loaded from a storage apparatus 508 into a random access memory (RAM) 503. In the RAM 503, various programs and data required for operations of the electronic device 500 are also stored. The processing apparatus 501, the ROM 502 and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a magnetic tape, a hard disk, etc.; and a communication apparatus 509. The communication apparatus 509 may allow the electronic device 500 to perform wireless or wired communication with other devices to exchange data. While the electronic device 500 with various apparatuses is shown in the FIG. 4, it should be understood that it is not required to implement or have all the apparatuses shown. More or fewer apparatuses may alternatively be implemented or provided.

In particular, according to the embodiments of the present disclosure, processes described above with reference to the flowchart may be implemented as a computer software program. For example, an embodiment of the present disclosure includes a computer program product, which includes a computer program carried on a computer-readable medium, the computer program including program codes for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above functions defined in the method of the embodiment of the present disclosure are performed.

It should be noted that the computer-readable medium mentioned above in the embodiments of the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the embodiments of the present disclosure, the computer-readable storage medium may be any tangible medium containing or storing a program, which program may be used by or in combination with an instruction execution system, apparatus or device. In the embodiments of the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium, and may send, propagate or transmit a program used by or in combination with an instruction execution system, apparatus or device. The program codes contained in the computer-readable medium may be transmitted by any suitable medium, including but not limited to: electric wires, optical cables, radio frequency (RF) and the like, or any suitable combination of the above.

In some implementations, the client and the server can communicate by using any currently known or future developed network protocol such as a hypertext transfer protocol (HTTP), and may be interconnected with digital data communication in any form or medium (for example, a communication network). Examples of the communication network include a local area network (LAN), a wide area network (WAN), the Internet work (for example, the Internet) and an end-to-end network (for example, an ad hoc end-to-end network), as well as any currently known or future developed networks.

The computer-readable medium may be included in the electronic device; or it may exist alone without being assembled into the electronic device.

The computer-readable medium described above carries one or more programs, which, when executed by the electronic device, cause the electronic device to perform the method of the embodiments of the present disclosure.

Computer program codes for performing the operations of the embodiments of the present disclosure may be written in one or more programming languages or combinations thereof, including object-oriented programming languages such as Java, Smalltalk and C++, and conventional procedural programming languages such as “C” or similar programming languages. The program codes may be completely executed on a user computer, partially executed on the user computer, executed as an independent software package, partially executed on the user computer and partially executed on a remote computer, or completely executed on the remote computer or a server. In the case involving the remote computer, the remote computer may be connected to the user computer through any type of network, including a local area network (LAN) or a wide area network (WAN), or may be connected to an external computer (for example, through the Internet using an Internet service provider).

The flowchart and block diagrams in the drawings illustrate architectures, functions and operations of possible implementations of the systems, methods and the computer program product according to various embodiments of the present disclosure. In this regard, each block in the flowchart or block diagram may represent a part of a module, a program segment, or codes, which includes one or more executable instructions for implementing specified logical functions. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. The name of the unit does not constitute a limitation on the unit itself in some cases.

The functions described above herein may be at least partially performed by one or more hardware logic components. For example, without limitation, exemplary types of hardware logic components that may be used include: a field programmable gate array (FPGA), an application-specific integrated circuit (ASIC), an application specific standard product (ASSP), a system-on-chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, there is provided a reconstruction method of a human avatar, including: acquiring a plurality of images having a human body and a virtual human body dataset; acquiring a depth map from the plurality of images; and performing, based on the plurality of images, the depth map and the virtual human body dataset, three-dimensional reconstruction and rendering by using a trained neural network model to obtain a three-dimensional human body model and a corresponding rendered image.

According to one or more embodiments of the present disclosure, performing, based on the plurality of images, the depth map and the virtual human body dataset, three-dimensional reconstruction and rendering by using a trained neural network model to obtain a three-dimensional human body model and a corresponding rendered image includes: acquiring a shape parameter and a first pose parameter of the human body from the plurality of images; generating, based on the shape parameter and the first pose parameter, an initial three-dimensional human body template mesh; generating, based on the initial three-dimensional human body template mesh, initial Gaussian mixture model parameters; generating, based on the initial Gaussian mixture model parameters, a density field and a color field of a three-dimensional scene; generating, based on the initial Gaussian mixture model parameters, the first pose parameter and a second pose parameter from the virtual human body dataset, deformed Gaussian mixture model parameters; and obtaining, based on the deformed Gaussian mixture model parameters and external parameters and internal parameters of a camera for acquiring the plurality of images, the three-dimensional human body model and the corresponding rendered image.

According to one or more embodiments of the present disclosure, the generating, based on the initial three-dimensional human body template mesh, initial Gaussian mixture model parameters includes: taking vertices of the initial three-dimensional human body template mesh as point cloud locations of a Gaussian mixture model, and initializing parameters of the Gaussian-mixture model by using a normal direction of a mesh face as a depth direction, to generate the initial Gaussian mixture model parameters.

According to one or more embodiments of the present disclosure, the generating, based on the initial Gaussian mixture model parameters, a density field and a color field of a three-dimensional scene includes: determining a Gaussian density for each Gaussian component; determining, based on the Gaussian density, a color of the corresponding Gaussian component; and determining, based on the Gaussian density and the color of each Gaussian component, the density field and the color field of the three-dimensional scene.

According to one or more embodiments of the present disclosure, the generating, based on the initial Gaussian mixture model parameters, the first pose parameter and a second pose parameter from the virtual human body dataset, deformed Gaussian mixture model parameters includes: using a learnable skinning weight to enable each Gaussian component to deform by using the first pose parameter and the second pose parameter; and determining the transformation of the Gaussian component and determining a deformed mean and rotation to determine deformed Gaussian mixture model parameters.

According to one or more embodiments of the present disclosure, the obtaining, based on the deformed Gaussian mixture model parameters and external parameters and internal parameters of a camera for acquiring the plurality of images, the three-dimensional human body model and the corresponding rendered image includes: converting a mean, a covariance, a color and a density of three-dimensional Gaussian into a two-dimensional representation.

According to one or more embodiments of the present disclosure, in a training process of the neural network model, a reconstruction loss function, a depth consistency loss function, a score distillation sampling generation loss function and a color gamut consistency loss function are used for model supervision.

According to one or more embodiments of the present disclosure, there is provided an reconstruction apparatus of a human avatar, including: an image and dataset acquisition module configured to acquire a plurality of images having a human body and a virtual human body dataset; a depth map acquisition module configured to acquire a depth map from the plurality of images; and a model construction and rendering module configured to perform, based on the plurality of images, the depth map and the virtual human body dataset, three-dimensional reconstruction and rendering by using a trained neural network model to obtain a three-dimensional human body model and a corresponding rendered image.

According to one or more embodiments of the present disclosure, there is provided an electric device, including: at least one memory and at least one processor, wherein the at least one memory is configured to store program codes, and the at least one processor is configured to execute the program codes stored in the at least one memory to perform any one of the methods described above.

According to one or more embodiments of the present disclosure, there is provided a non-transitory computer-readable storage medium, wherein the non-transitory computer-readable storage medium is configured to store program codes, and the program codes are configured to perform the method described above.

The foregoing description is only exemplary of the preferred embodiments of the present disclosure and is illustrative of the principles of the technology employed. It will be appreciated by those skilled in the art that the scope of the present disclosure herein is not limited to the particular combination of technical features described above, but also encompasses other combinations of features described above or equivalents thereof without departing from the spirit of the present disclosure. For example, the above features are replaced with (but not limited to) technical features with similar functions disclosed in the present disclosure.

Moreover, although the operations are depicted in a particular order, this should not be understood as requiring that these operations be performed in the particular order shown or in a sequential order. Under certain circumstances, multitasking and parallel processing may be beneficial. Likewise, while several specific implementation details are included in the above discussion, these should not be construed as limitations on the scope of the present disclosure. Some features described in the context of separate embodiments can also be combined in a single embodiment. On the contrary, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. On the contrary, the specific features and acts described above are merely exemplary forms of implementing the claims.

1. A reconstruction method of a human avatar, comprising:
acquiring a plurality of images having a human body and a virtual human body dataset;
acquiring a depth map from the plurality of images;
performing, based on the plurality of images, the depth map and the virtual human body dataset, three-dimensional reconstruction and rendering by using a trained neural network model to obtain a three-dimensional human body model and a corresponding rendered image.

2. The reconstruction method of the human avatar according to claim 1, wherein the performing, based on the plurality of images, the depth map and the virtual human body dataset, three-dimensional reconstruction and rendering by using a trained neural network model to obtain a three-dimensional human body model and a corresponding rendered image comprises:
acquiring a shape parameter and a first pose parameter of the human body from the plurality of images;
generating, based on the shape parameter and the first pose parameter, an initial three-dimensional human body template mesh;
generating, based on the initial three-dimensional human body template mesh, initial Gaussian mixture model parameters;
generating, based on the initial Gaussian mixture model parameters, a density field and a color field of a three-dimensional scene;
generating, based on the initial Gaussian mixture model parameters, the first pose parameter, and a second pose parameter from the virtual human body dataset, deformed Gaussian mixture model parameters; and
obtaining, based on the deformed Gaussian mixture model parameters as well as external parameters and internal parameters of a camera for acquiring the plurality of images, the three-dimensional human body model and the corresponding rendered image.

3. The reconstruction method of the human avatar according to claim 2, wherein the generating, based on the initial three-dimensional human body template mesh, initial Gaussian mixture model parameters comprises:
taking vertices of the initial three-dimensional human body template mesh as point cloud locations of a Gaussian mixture model, and initializing parameters of the Gaussian-mixture model by using a normal direction of a mesh face as a depth direction, to generate the initial Gaussian mixture model parameters.

4. The reconstruction method of the human avatar according to claim 2, wherein the generating, based on the initial Gaussian mixture model parameters, a density field and a color field of a three-dimensional scene comprises:
determining a Gaussian density for each Gaussian component;
determining a color of corresponding Gaussian component based on the Gaussian density; and
determining, based on the Gaussian density and the color of each Gaussian component, the density field and the color field of the three-dimensional scene.

5. The reconstruction method of the human avatar according to claim 2, wherein the generating, based on the initial Gaussian mixture model parameters, the first pose parameter and a second pose parameter from the virtual human body dataset, deformed Gaussian mixture model parameters, comprises:
using a learnable skinning weight to enable each Gaussian component to deform by using the first pose parameter and the second pose parameter; and
determining transformation of the Gaussian component and determining a deformed mean and rotation to determine deformed Gaussian mixture model parameters.

6. The reconstruction method of the human avatar according to claim 2, wherein the obtaining, based on the deformed Gaussian mixture model parameters and external parameters and internal parameters of a camera for acquiring the plurality of images, the three-dimensional human body model and the corresponding rendered image comprises:
converting a mean, a covariance, a color and a density of three-dimensional Gaussian into a two-dimensional representation.

7. The reconstruction method of the human avatar according to claim 1, wherein in a training process of the neural network model, a reconstruction loss function, a depth consistency loss function, a score distillation sampling generation loss function and a color gamut consistency loss function are used for model supervision.

8. The reconstruction method of the human avatar according to claim 7, wherein a process of generating SDS loss of the score distillation sampling generation loss function comprises: use of the pre-trained diffusion model, the generative model and optimization, score distillation, and loss calculation.

9. The reconstruction method of the human avatar according to claim 1,
wherein the neural network model is constructed and trained by using deep learning framework,
wherein a plurality of preprocessed RGB images, a depth map and a corresponding virtual human body dataset are input into the neural network model, and the neural network model outputs the three-dimensional human body model and the corresponding rendered image.

10. The reconstruction method of the human avatar according to claim 1, wherein the neural network model is algorithmically tested, which comprises: model verification, performance evaluation, result presentation and iterative optimization.

11. An electronic device, comprising:
at least one memory;
at least one processor,
wherein the at least one memory is configured to store program codes, and the at least one processor is configured to execute the program codes stored in the at least one memory to perform a reconstruction method of a human avatar,
wherein the reconstruction method of the human avatar comprises:
acquiring a plurality of images having a human body and a virtual human body dataset;
acquiring a depth map from the plurality of images;
performing, based on the plurality of images, the depth map and the virtual human body dataset, three-dimensional reconstruction and rendering by using a trained neural network model to obtain a three-dimensional human body model and a corresponding rendered image.

12. The electronic device according to claim 11, wherein the performing, based on the plurality of images, the depth map and the virtual human body dataset, three-dimensional reconstruction and rendering by using a trained neural network model to obtain a three-dimensional human body model and a corresponding rendered image comprises:
acquiring a shape parameter and a first pose parameter of the human body from the plurality of images;
generating, based on the shape parameter and the first pose parameter, an initial three-dimensional human body template mesh;
generating, based on the initial three-dimensional human body template mesh, initial Gaussian mixture model parameters;
generating, based on the initial Gaussian mixture model parameters, a density field and a color field of a three-dimensional scene;
generating, based on the initial Gaussian mixture model parameters, the first pose parameter, and a second pose parameter from the virtual human body dataset, deformed Gaussian mixture model parameters; and
obtaining, based on the deformed Gaussian mixture model parameters as well as external parameters and internal parameters of a camera for acquiring the plurality of images, the three-dimensional human body model and the corresponding rendered image.

13. The electronic device according to claim 12, wherein the generating, based on the initial three-dimensional human body template mesh, initial Gaussian mixture model parameters comprises:
taking vertices of the initial three-dimensional human body template mesh as point cloud locations of a Gaussian mixture model, and initializing parameters of the Gaussian-mixture model by using a normal direction of a mesh face as a depth direction, to generate the initial Gaussian mixture model parameters.

14. The electronic device according to claim 12, wherein the generating, based on the initial Gaussian mixture model parameters, a density field and a color field of a three-dimensional scene comprises:
determining a Gaussian density for each Gaussian component;
determining a color of corresponding Gaussian component based on the Gaussian density; and
determining, based on the Gaussian density and the color of each Gaussian component, the density field and the color field of the three-dimensional scene.

15. The electronic device according to claim 12, wherein the generating, based on the initial Gaussian mixture model parameters, the first pose parameter and a second pose parameter from the virtual human body dataset, deformed Gaussian mixture model parameters, comprises:
using a learnable skinning weight to enable each Gaussian component to deform by using the first pose parameter and the second pose parameter; and
determining transformation of the Gaussian component and determining a deformed mean and rotation to determine deformed Gaussian mixture model parameters.

16. The electronic device according to claim 12, wherein the obtaining, based on the deformed Gaussian mixture model parameters and external parameters and internal parameters of a camera for acquiring the plurality of images, the three-dimensional human body model and the corresponding rendered image comprises:
converting a mean, a covariance, a color and a density of three-dimensional Gaussian into a two-dimensional representation.

17. The electronic device according to claim 11, wherein in a training process of the neural network model, a reconstruction loss function, a depth consistency loss function, a score distillation sampling generation loss function and a color gamut consistency loss function are used for model supervision.

18. The electronic device according to claim 17, wherein a flow of SDS generation loss of the score distillation sampling generation loss function comprises: use of the pre-trained diffusion model, the generative model and optimization, score distillation, and loss calculation.

19. The electronic device according to claim 11,
wherein the neural network model is constructed and trained by using deep learning framework,
wherein a plurality of preprocessed RGB images, a depth map and a corresponding virtual human body dataset are input the neural network model, and the neural network model outputs the three-dimensional human body model and the corresponding rendered image.

20. A non-transitory computer-readable storage medium, wherein the non-transitory computer-readable storage medium is configured to store program codes, and the program codes are configured to perform a reconstruction method of a human avatar,
wherein the reconstruction method of a human avatar comprises:
acquiring a plurality of images having a human body and a virtual human body dataset;
acquiring a depth map from the plurality of images;
performing, based on the plurality of images, the depth map and the virtual human body dataset, three-dimensional reconstruction and rendering by using a trained neural network model to obtain a three-dimensional human body model and a corresponding rendered image.
